(19) United States
(12) Patent Application Publication
(10) Pub. No.: US 2025/0380097 A1
(43) Pub. Date: Dec. 11, 2025

(54) Vent-dependent fitting system steering

(71) Applicant: SONOVA AG, Staefa (CH)

(72) Inventors: Philipp Kohlhauer, Uerikon (CH); Stefan Raufer, Stäfa (CH); Volker Kühnel, Männedorf (CH)

(21) Appl. No.: 19/229,442

(22) Filed: Jun. 5, 2025

(30) Foreign Application Priority Data
Jun. 6, 2024 (EP) 24180531.6

(51) Int. Cl. H04R 25/00

(52) U.S. Cl. CPC H04R 25/70; H04R 25/43; H04R 25/507; H04R 2225/41; H04R 2225/43; H04R 2460/01; H04R 2460/11

(57) ABSTRACT

A method for fitting a hearing device to an end user, wherein the hearing device has as a vent, wherein the method comprises the steps of: a) providing a hearing device having a first sound enhancement setting; b) providing a fitting software, c) feeding a vent cut-off frequency value of the hearing device to the fitting software, d) calculating a strength value based on the vent cut-off frequency value, e) calculating a second sound enhancement setting based on that strength value, f) replacing the first sound enhancement setting in the fitting software by the second sound enhancement setting, g) establishing a new set of hearing device settings for the hearing device, and h) transmitting the new set of hearing device settings to the hearing device.

### RELATED APPLICATIONS

The present application claims priority to EP patent application Ser. No. 24/180,531.6, filed Jun. 6, 2024, which is hereby incorporated by reference in its entirety.

### BACKGROUND INFORMATION

Hearing devices are nowadays dimensionally small and complex devices. Hearing devices can include a microphone, a processor, memory, and other electronical and mechanical components to form an audio signal processor plus a speaker/receiver to emit a sound towards the eardrum, eventually. Types of such hearing devices are Behind-The-Ear (BTE), Receiver-In-Canal (RIC), In-The-Ear (ITE), Completely-In-Canal (CIC), Invisible-In-The-Canal (IIC) devices and in-ear phones. The selection of the type of hearing devices that suits an end user depends on factors like the hearing loss, aesthetic preferences, lifestyle needs, and budget. The term “end user” denotes the user of the hearing device.

Hearing systems and devices with audio signal processing are well known in the art. Audio signal processing may comprise noise reduction routines for reducing or even removing, undesired sound that is not relevant to the end user, which sound is commonly referred to as acoustic noise.

Hearing devices provide many signal processing features, which can improve speech intelligibility and listening comfort. The perceptual effect of these features depends on the acoustic coupling to the ear canal. The acoustic coupling has an acoustic vent mass, which is directly related to a cut-off frequency, and below which the effectiveness of the hearing device decreases and below which direct sound from the environment reaches the ear drum and can mask, i.e., can dominate over the processed audio signal from the hearing device.

Once the noise is removed from an input signal, the clarity of a target audio signal contained in the input audio signal is improved substantially. That signal processing is referred to as speech enhancement. Unfortunately, noise reduction, often also referred to as noise cancellation, denoising or noise suppression and its routines are prone to errors and artifacts depending on signal properties of the input signal and on the noise reduction algorithm used. At poor signal-to-noise ratios (SNR) of the input audio signal, noise reduction routines may corrupt and suppress the noise but also the target audio signal and thereby counteracting to the overall purpose of a better understandability of spoken content.

In the process of fitting the hearing devices to the needs and preferences of the end user, the hearing care specialist (HCP) selects an appropriate acoustic coupling for the end user. This acoustic coupling is then used in the calculation of an individual gain curve to optimally compensate for the end user's hearing loss. Besides the hearing loss (e.g. measured by means of an audiogram), also parameters of the hearing device are considered in the fitting process. The fitting process usually involves a fitting software running on a computer or processing device, the input of parameters by the HCP into the fitting software and the output of the recommended settings by the fitting software, the transfer of parameters to the hearing device, evaluation of the settings by the end user and many more. During the fitting process, the HCP selects the acoustic coupling for the end user of the hearing device.

An exemplary representative of a method to provide input parameters for a hearing instrument is disclosed in WO2009/087241A3.

The hearing devices may use so-called universal domes or tailored earpieces to establish a snug fit in the end user's ear canal.

A vent is a channel extending between the inside of the ear canal and the outside and the ambient environment (i.e. the region of the pinna) and allows, amongst other effects, for a pressure equalization between those regions when the hearing device is worn. Vents are well-known means to lower undesired acoustic effects like occlusion and sound artifacts and contribute to a better-balanced microclimate with respect to humidity. Although an acoustically closed coupling is preferable in some use situations, an acoustically open coupling can be desired in other use situations (own-voice, environmental awareness). A vent renders a closed coupling towards an open coupling, dependent on the vent size. With an individualized vent size and thus the vent cut-off frequency and the acoustic vent mass (AVM), tailored solutions to the end user's hearing loss become possible. The AVM is proportional to the effective cross-section A of the vent in the propagating direction of the sound.

$$AVM \sim 1 / A$$

The term “signal processing” comprises at least a speech enhancement, a noise reduction, and a gain curve calculation, especially the insertion gain curve.

A problem of the present fitting process exists in that the end users will in a first initial fit often not profit from an optimal or preferred fitting parameter set of their hearing devices since not all individual aspects of the hearing device available are carefully considered.

### BRIEF DESCRIPTION OF THE DRAWINGS

Below, embodiments are described in more detail with reference to the attached drawings.

FIG. 1 shows a generic diagram of coupling an input audio signal to the ear canal of the end user whose hearing device has a vent;

FIG. 2 shows the occlusion gain of the vent-transmitted sound path (real ear occluded gain, REOG) for vents of different sizes in an earmold or custom shell with a mean canal stalk length of 7 mm;

FIG. 3 shows details of the flowchart of a fitting method embodiment;

FIG. 4 shows details of the flowchart of the signal processing in the hearing device in accordance to a fitting method described herein;

FIG. 5 is a diagram illustrating an optimized strength value depending on the vent cut-off frequency;

FIG. 6 illustrates the statistic result of end user test outcome to an illustrative strength value applied to the noise reduction processing unit under the test condition of a restaurant sound scene with lots of ambient noise and an almost closed acoustic coupling;

FIG. 7 illustrates the statistic result of end user test outcome to an illustrative strength value applied to the noise reduction processing unit under the test condition of the same restaurant sound scene as for the diagram in FIG. 6, but an open acoustic coupling;

FIG. 8 shows a schematic diagram displaying the broadband signal-to-noise ratio benefit for an end user as a function of the vent cut-off frequency if the strength value is kept constant for all vent cut-off frequencies;

FIG. 9 shows a diagram where the strength value for a noise reduction is continuously monotonically mapped to the vent cut-off frequency; and

FIG. 10 shows a diagram where the strength value for a noise reduction strength is mapped to the vent cut-off frequency in a step wise manner.

### DETAILED DESCRIPTION

Described herein are a method for fitting a hearing device to an end user, wherein the hearing device has a vent. The fitting involves a computer program commonly referred to as a fitting software and a computer-readable medium with such a fitting software.

Therefore, embodiments described herein provide for an improved fitting method that ensures that the end users of hearing devices can profit optimally from preferred initial sound processing setting of their hearing devices.

A further feature described herein resides in providing a computer program product forming a fitting software and a computer-readable storage medium comprising such a fitting software.

The above benefit is achievable by the subject-matter according to the independent claims and the use of the computer program product with such a fitting method accordingly. Further exemplary embodiments are evident from the subject-matter according to the dependent claims and the following description.

In its basic embodiment, the method for fitting a hearing device to an end user is as follows. Eventually, an eardrum of that end user receives a mix of a direct sound of an input audio signal received via the vent and a processed sound of the input audio signal processed by the hearing device when the end user is exposed to the input audio signal.

The method comprises the following steps:
a) Providing a hearing device having a first sound enhancement setting.
b) Providing a fitting software (12) running of a fitting computer.

Additional steps like connecting the hearing device to the fitting software and identifying the hearing device in the fitting software are present, too, but they are not mentioned in detail here since they are known in the art.
c) Feeding a vent cut-off frequency value of the hearing device to the fitting software.

The feeding can also take place indirectly in that the HCP enters the acoustic properties of a hearing device into the fitting software and the fitting software derives the corresponding vent cut-off frequency from a lookup library of the fitting software.
d) Calculating a strength value based on the vent cut-off frequency value. Step d) is done in that the fitting software extracts its built-in lookup table a strength value that corresponds to the vent cut-off frequency value.
e) Calculating/generating a second sound enhancement setting based on that strength value. Thus, the strength value can be used to control the sound enhancement setting in the hearing device. For example, the sound enhancement setting can comprise a noise reduction setting, a speech enhancement setting or a combination thereof. In other words, the strength value automatically steers a degree of the intensity of the sound enhancement during the fitting process. If required, there may be a coefficient inserted between the strength value and the sound enhancement setting of the fitting software.

Depending on the steering set-up of the processing units responsible for the sound enhancement, the strength value can be an integer or another mathematical value or a corresponding control code taken by the method from a library. If the calculated strength value or strength values (in case they differ to one another for the noise reduction and the speech recognition) is displayed in the fitting software, the HCP may gain a better overview about the settings. The display may come in the form of sliders, or another suitable adjustment means. In case that a merging of the audio signal from the sound enhancement processing unit and the bypass that bypasses the sound enhancement processing unit (that will be explained in more detail later) is frequency dependent, the strength value can be a vector.

Next, in step f), the first sound enhancement setting in the fitting software is replaced by the second sound enhancement setting calculated/generated in the fitting software automatically. If the second sound enhancement setting is identical to the first sound enhancement setting, the setting is overwritten by the second sound enhancement setting nonetheless, as this is the simplest procedure.

Once that is done, the fitting software establishes a new set of hearing device settings for the hearing device in step g). That new set of hearing device settings will reprogram and adjust the first sound enhancement setting that were present before the initial fitting process, i.e., previous to step a).

In step h), the new set of hearing device settings is transmitted to the hearing device and the hearing device is reprogrammed accordingly.

A major advantage of that method resides in that the correct vent mass and thus the correct vent cut-off frequency is considered automatically during the fitting process promoted herein. The goal resides in adjusting the default sound enhancement strength by the fitting software such that the end user can benefit maximally from optimal gearing device settings.

For example, with a so called open acoustic coupling involving open domes where there are openings and thus vents that allow a substantial amount of direct sound to enter the ear canal, the vent cut-off frequency is bigger than, for example, 1.3 kHz and the AVM would be less than 1. Without the embodiments described herein, the end user profits less from sound enhancement in such a sound scene if the first sound enhancement setting was left on its default value. Different thereto in the same sound scene and with the same acoustic coupling where the user profits from a better initial fitting process and from an optimized sound enhancement since the new set of hearing device settings calculated by the fitting software automatically considers the correct vent size and adjusts the first sound enhancement settings that are often different to the default first sound enhancement settings in the fitting software.

The connection of the hearing device to the fitting software and the transmission of the set of parameters from the fitting software to the hearing device in step h) can be performed wirelessly or via cables. A suitable wireless data connection may be Bluetooth based connection or another low power proprietary protocol, for example.

Thanks to the automatic control/steering of the strength value and thus the operation strength of the sound enhancement, the end user is less dependent on the HCP's awareness to consider amending the default vent cut-off frequency in the fitting software manually. Embodiments described herein can also be used in an automatic fitting procedure. Here the cut-off frequency might be stored electronically in the information in the hearing device, in the specific dome or a user manual.

Now let us focus on the effects of the method step h) to the hearing device once the hearing device is in use. In a processed sound path a digital audio signal of the analog input sound signal is present and ready for signal processing. The audio signal can be a pre-processed signal, e.g., an audio signal originating resulting of a beamforming process. Hence the blanket term “audio signal” is used hereinafter to denote the electronic signal in the processed sound path and does not change its name after each sound enhancement step. Once the hearing device is in use, the audio signal is fed to a sound enhancement processing unit and a bypass that bypasses the sound enhancement processing unit in the hearing device, followed by a merging of the audio signal from the sound enhancement processing unit and the audio signal from the bypass in a mixing ratio defined by the new set of hearing device settings that are based on the strength value.

Note that it may be beneficial to always keep at least a minimal weight factor for the audio sound ratio from the bypass such that the mixing ratio never becomes 100% sound enhanced signal to 0% (zero) audio signal from the bypass. Weighting can take place by way of scaling the amount of spectro-temporal filtering. Having a minimal percentage of unprocessed audio signal from the bypass helps in managing and suppressing undesired artifacts and leads to a better, more natural sound perception of the outcome at the end user.

The merging of the audio signal coming from the sound enhancement processing unit and the audio signal coming from the bypass is technically achieved by way of a weighting of the sound signal from the sound enhancement processing unit and the sound signal from the bypass depending on the mixing ratio.

To compensate for a time delay caused by the processing of the sound signal in the sound enhancement processing unit, the signal in the bypass is delayed such that it is brought in sync with the audio signal leaving the sound enhancement processing unit, again.

Regarding the filtering of the noise, best results for the end user are achievable if the second sound enhancement setting comprises a second noise reduction setting for a noise reduction.

Most likely, the noise reduction setting comprises at least one of the following functionalities:
Wiener-filter based SNR controlled gain reduction;
Reduce comb filter effect;
Sound relaxation, for example an impulse noise reduction;
A noise reduction processing unit comprising a DNN model.

Noise reduction, also referred to as denoising is understood here as a real-time separation of speech or desired sound information from acoustic noise and involves the elimination of such undesired noise to enhance the clarity of speech since that is the essence the end user hears.

Albeit reducing the amount of undesired background noise to improve speech intelligibility and reduce listening effort from a sound scene can be improved by way of beamforming in today's hearing devices, the sound scene of a conversation in a noisy environment is still a challenge for many end users today and leads to the least satisfaction of the end user of a hearing device. This particularly in complex sound scenes like a restaurant with lots of background noise, for example. A classic situation is when the hearing-impaired end user sits at a table with several persons and wants to follow a conversation without the need of looking at the speaker-which can be challenging, if not impossible if several spatially separated persons talk at the same time. Here, the advantage of a deep neural network (DNN) is welcomed to mitigate the disadvantages at least to some extent. Using the DNN can contribute to an increased and thus desirable acoustic contrast of the audio signals of a speech and audio signals of acoustic noise.

Compared to a training set-up involving a machine learning process to teach the noise reduction processing unit on how to reduce the noise best, tests proved that even better SNR results are achievable by using a DNN. With a higher number of parameters, given enough data points and a suitable optimization procedure, a DNN model can adapt to a large variety of acoustic problems with unprecedented generalization capabilities, where a traditional machine learning model (ML) has stricter delimitations to adapt to new acoustic situations.

In more detail, the DNN was employed to produce a DNN model for the noise reduction processing unit located in the hearing device. The term “DNN unit” provided in the hearing device shall not to be confused with the term “DNN”.

The DNN is a truly self-learning device that can mimic a human brain, process input, draw conclusions and develop. A DNN comprises multiple non-linear computational units or neurons organized in a layer-wise fashion to extract high-level, deeper, robust, and discriminative features from the underlying data. Different DNN network architectures are available, such as a U-net with several layers and nodes.

Different thereto, the DNN unit is no self-learning device but a non-dynamic model comprising many algorithms that represent the sum of knowledge and lessons learned of the DNN at a specific moment in time. The DNN unit can operate independently from the DNN, requires less space and consumes less power than the DNN once the model is stored in the sound enhancement processing unit such as the noise reduction processing unit and/or the speech enhancement processing unit, for example. The DNN is therefore locatable at a distance from the fitting computer with its fitting software and the hearing device.

It is possible to enrich, complement and improve the knowledge level of the DNN unit of the fitting system hearing device by newer knowledge and lessons learned by the DNN in that a newer DNN model is transmitted to the hearing device every now and then, e.g., by way of an update. Such an update can take place via an online connection between the hearing device and an entity that creates the models of the DNN or just stores them, for example.

The DNN unit contains a model with a weighting of training data, the speech quality, the total sound quality, and noise reduction to arrive at an optimal SNR with a low level of sound artifacts only.

Dependent on a variety of factors, today's hearing devices can improve the SNR of a moderately challenging environment by approximately 4-8 dB SNR. In comparison, DNN units with the models from the DNNs have the potential to improve the SNR towards 11 dB today. That way, it becomes possible to rely less on traditional signal processing techniques for noise reduction such as beamformers, for example.

Besides a noise reduction, the SNR can also be improved by speech enhancement measures. These speech enhancement measures can be controlled advantageously in that the second sound enhancement setting comprises a second speech enhancement setting directed to that speech enhancement.

Most likely, the speech enhancement setting comprises at least one of the following functionalities:
accentuating acoustic signals arising of the input audio signal in a range of about 500 Hz to about 3000 Hz. The frequency range of about 500 Hz to about 3000 Hz is also known as the middle frequency range or the main speech region.
enhancement of spectral shape;
enhancement of intensity;
speech pattern processing;
enhancement by re-synthesis. That includes procedures to the speech style, speech interruptions like stammering, translations from the language of a speaker to a preferred language of the user fitted with the hearing device;
a enhancement processing unit comprising a DNN model.

The advantages to the use of a DNN and a DNN unit mentioned in the context of a noise reduction above hold true for a speech enhancement likewise.

If both a noise reduction and a speech enhancement processing are desired, it is possible to run these processes in series one after another, or in parallel to one another, whatever is preferred.

If a higher complexity of the DNN unit is permitted, the noise reduction and the speech enhancement can be processed in the same DNN unit. Alternatively, the processing of the noise reduction and the speech enhancement processing in separate DNN units.

The end users can profit most from their hearing devices if the sound enhancement comprises both a speech enhancement as well as a noise reduction. In such a case, the mixing ratio comprises a first mixing ratio for the noise reduction and a second mixing ratio for the speech enhancement.

In more detail, the following actions take place in the hearing device in such a case:
i. The audio signal is fed to a noise reduction processing unit and a first bypass that bypasses the noise reduction processing unit in the hearing device. Next, the audio signal from the noise reduction processing unit and the audio signal from the first bypass are reunited in a step of a first merging. That first merging involves a step of a selective combination of a first mixing ratio of both audio signals to one another since the first merging is not a mere addition of the audio signal from the noise reduction processing unit and the audio signal from the first bypass. That first mixing ratio is defined by the new set of hearing device settings based on the strength value.
ii. The audio signal is fed to a speech enhancement processing unit and a second bypass that bypasses the speech enhancement processing unit in the hearing device. Next, the audio signal from the speech enhancement processing unit and the audio signal from the second bypass are reunited in a step of a second merging. That second merging involves a step of a selective combination of a second mixing ratio of both audio signals to one another since the second merging is not a mere addition of the audio signal from the speech enhancement processing unit and the audio signal from the second bypass. That second mixing ratio is defined by the new set of hearing device settings based on the strength value.

It is possible that the first mixing ratio is different to the second mixing ratio. That difference can be realized in that different coefficients are applied to the strength value. The coefficients can be already contained in the lookup library or applied locally in or near the sound processing unit or units.

Depending on the embodiment of the fitting software, the vent cut-off frequency value is fed to the fitting software by way of one of the following ways:
a default value obtained by the fitting software from a library based on an audiogram;
a coupling code that is fed into the fitting software;
the selection of an earpiece type and a vent size from a menu in the fitting software;
measurement results of a feedback test saved in the fitting software.

Depending on the operability and the handling instructions of the fitting software, the vent cut-off frequency value is fed to the fitting software by way of a pulldown menu of the earpiece or dome, and automated reading or scanning of the coupling code that is printed on the custom earpiece, a pulldown menu for the AVM values in the fitting software, or a scanning of the hearing device. All that can spare the HCP from having to type the cut-off frequency or any other of these related values into the fitting software manually. As a result, further human errors owing to mistyping are reducible that way. In alternative embodiments, the coupling code is saved within the electronic piece of the hearing piece and can be transmitted to the fitting software by way of a scanner for further use.

Note that the term “fed” implies intermediate calculations performed by the fitting software, e.g., a transformation of the coupling code to the vent cut-off frequency value where needed.

In a basic embodiment of the method, a two-stage strength value model is applied. That model resides in that the fitting software applies a first strength value if the vent cut-off frequency entered to the fitting software is below a predefined vent cut-off frequency threshold value. If the vent cut-off frequency value entered to the fitting software is at or above that predefined vent cut-off frequency threshold value, the fitting software applies a second strength value, whereas the second strength value is different to the first strength value. The two strength values and its corresponding vent cut-off frequencies are contained in a lookup table of the fitting software.

In a more advanced embodiment of the method, there may be more frequency ranges separated from one another by dedicated vent cut-off frequencies, each, allowing a more granular fine-tuning of the optimal strength value.

In cases where sharp changes of the noise reduction and/or speech enhancement depending on the frequency are undesired and shall be avoided, the strength value is mappable to the vent cut-off frequency value in a continuous monotonic way. Note that the term “monotonic” does not require the strength of the sound enhancement to be linear with respect to the vent cut-off frequency since there can be several stages/levels in the curve when displayed in a diagram where the sound enhancement strength is mapped to the vent cut-off frequency.

In an embodiment of the method allowing for a continuous adaption of the strength value, the strength value gets progressively higher, the higher the vent cut-off frequency is.

In case that a computer program product forms the fitting software, the above-mentioned benefits are available accordingly.

That computer program product can be stored on a non-transitory computer-readable storage medium. That storage medium can be a portable memory stick, a personal computer, or a dedicated fitting computer at the HCP, for example.

Depending on the set-up of the computer program and on the data processing speed required by the fitting software, the step of further sound tuning, filtering, and calculating a gain curve is performed sequentially after the calculation of the at least one the noise reduction setting and the speech enhancement setting, or in parallel to at least one of the latter two.

It shall be understood that features of the method as described in the above and in the following may be features of the computer program, the computer-readable medium as described above vice versa.

These and other aspects will be apparent from and elucidated with reference to the embodiments described hereinafter.

The reference characters used in the drawings are explained hereinafter, where required. Identical and functionally identic items are given the same reference characters in the figures.

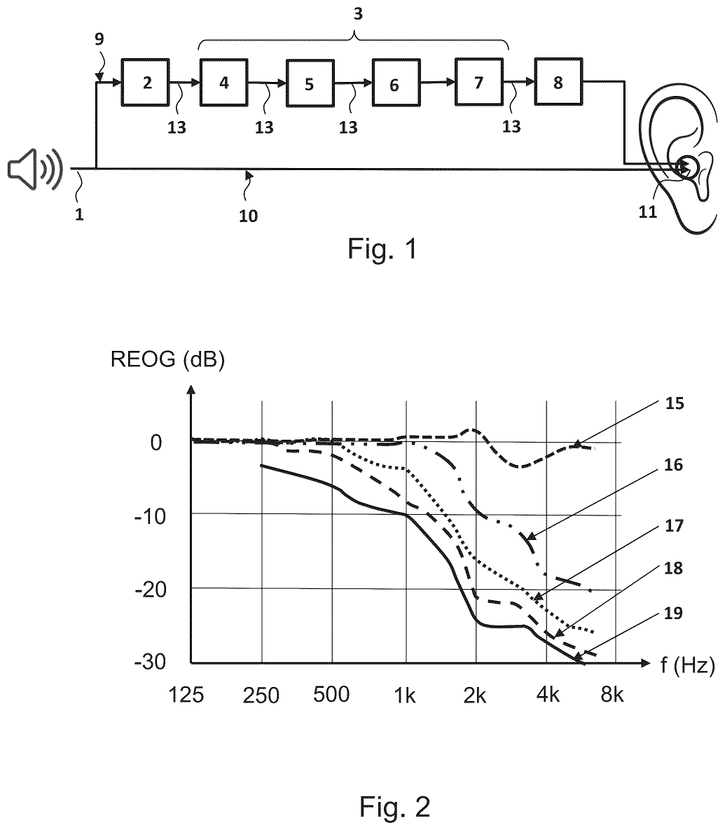

FIG. 1 depicts a generic diagram of coupling an input audio signal to the ear canal 11 of an end user of the hearing device. In the processed sound path 9, the input audio signal 1 emitted by a sound source is first received by a microphone 2, then converted into an electronic signal referred to as audio signal 13 hereinafter, and processed in a signal processing sequence 3 to compensate for the hearing loss of the end user at least in part. In the present embodiment, the signal processing sequence 3 involves a sound strength adjustment 4 (gain adjustment), followed by a noise reduction 5, a speech enhancement 6 and a further sound tuning (e.g., a filtering) 7, followed by emitting by way of a receiver 8 that converts the audio signal 13 back into acoustic sound to be led into a section of the ear canal 11 located after the custom shell 30 and before the eardrum.

In the present illustrative example, the hearing device is of Receiver-In-Canal (RIC) type with a dome (not shown). The dome is a rubbery-type shell element such as known from WO2023/051008A1, for example. Reference character 10 denotes the direct sound path along which the input audio signal 1 (direct audio signal) travels from the sound source via the vent channel of the earpiece of the hearing device into the ear canal 11 towards the eardrum.

FIG. 2 shows an overview about the REOG curves for different vent sizes but a mean canal stalk length of 7 mm to display the impact of different vent sizes on the hearing effect received by the end user. The ordinate shows the effective attenuation of input sound signals of different frequencies. FIG. 2 further shows that the sound damping of direct sound signals at higher frequencies is higher the closer the acoustic coupling.

The vent of the above-mentioned RIC mentioned in the context of FIG. 1 has an acoustic vent mass (AVM) that is equal to or smaller than 1 and a vent cut-off frequency of 1.5 kHz and thus leads to a curve like curve 16 in FIG. 2. Curve 15 denotes a curve for an open canal, i.e., a vent whose size is that big that it allows a lot of direct sound to enter the ear canal and pass through to the eardrum but also allows the sound before the eardrum to escape through the vent.

Reference character 19 denotes a curve for an occluded canal, i.e., an orthoplastic or earpiece with a very small sized vent channel only which prevents the input sound signal from entering the ear canal almost completely.

Curves labelled 16 to 18 relate to REOG curves with a vent-transmitted sound path between an open and an occluded canal.

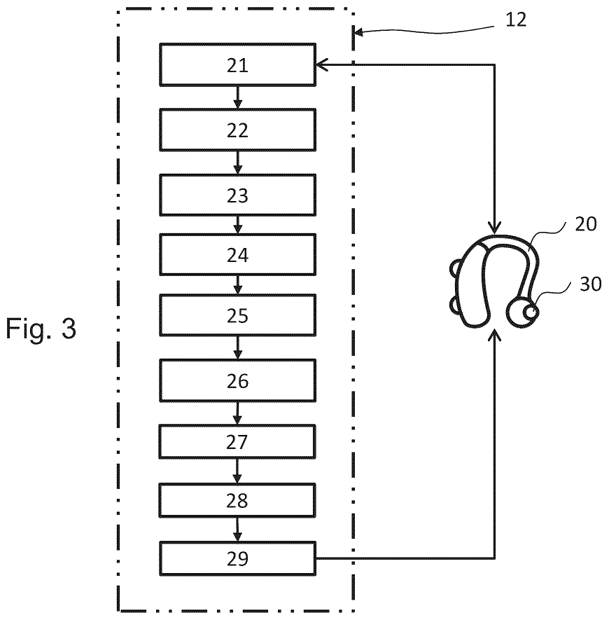

FIG. 3 shows a simplified flowchart of the major section of the fitting software 12 (indicated by the point-point-dashed line).

Said method comprises the step 21 of connecting the hearing device to the fitting software, the step 22 of identifying the hearing device 20 in the fitting software and feeding a vent cut-off frequency value corresponding to the vent size of the custom shell 30 from the hearing device 20 to the fitting software in step 23. In the present case, the end user had the custom shell 30 made for his/her ear canal 11. That custom shell 30 was already connected to the hearing device and had a specific vent and thus a specific vent size. When the HCP receives the custom shell 30, it comes along with a so-called coupling code. The HCP feeds that coupling code into the fitting software and the fitting software immediately determines the vent cut-off frequency value relating to that custom shell based on corresponding entry in the lookup library of the fitting software.

In alternative embodiment, the HCP enters the type of coupling (e.g., Sonova open dome) and in case of custom shell or earmold the vent size into the fitting software. This vent size contains the diameter is then converted to an AVM or vent cut-off frequency in the fitting software.

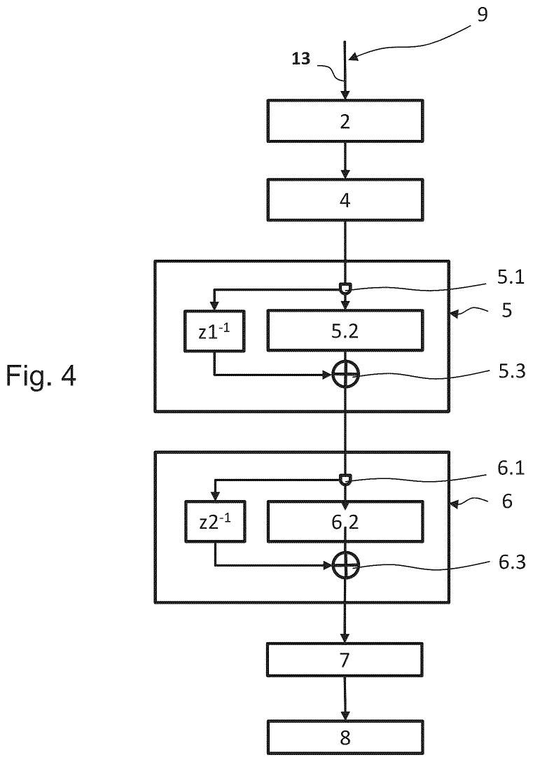

Next, the fitting software calculates 24 a strength value (sv) based on that vent cut-off frequency value and calculates a second sound enhancement setting based on that strength value. Depending on the embodiment, the term “setting” can comprise one or more values that play a role for establishing the new set of hearing device settings later. As we will see in the context of FIG. 4 showing an embodiment of a hearing device 20 that has both a noise reduction and a speech enhancement functionality, the second sound enhancement setting comprises a second noise reduction setting and a second speech enhancement setting.

In step 27, the existing first sound enhancement setting that was present in the fitting software before the first fitting process started, is now replaced by the second sound enhancement setting automatically. The term “existing settings” is understood as the default setting in the hearing device at the time of identifying the type of the hearing device at step 22.

After calculating the second speech enhancement setting in step explained in more detail in the context of FIG. 4 as calculating a second noise reduction setting 25 and a second speech enhancement setting 26, the first sound enhancement setting in the fitting software is replaced by the second sound enhancement setting in step 27 in the fitting software. Once that is done, the fitting software calculates a new set of hearing device settings in step 28 that is required to reprogram the hearing device accordingly. Finally, the new set of hearing device settings is transmitted wirelessly to the hearing device 20 in step 29 and triggers the re-programming of the hearing device 20 such that enables its functionality to the best benefit of the end user.

Although not shown in FIG. 3, further digital signal processing steps such as applying a post-filter gain may be present before step 28.

The schematic drawing of the digital signal processing shown and explained in the context of FIG. 4 shows some details of the audio signal 13 processing in the hearing device 20 in accordance with the fitting method described herein.

In this embodiment, a speech enhancement 6 follows a noise reduction 5 in the processed sound path 9 in an operating state of the hearing device after the initial fitting process.

Recall that the fitting software transmitted and reprogrammed the first sound enhancement settings of the hearing device 20 in step corresponding to flowchart step 29 in FIG. 3 is such that once the hearing device 20 is in use, an audio signal 13 arriving at a first splitter 5.1 is fed for a noise reduction (5) into a noise reduction processing unit 5.2 and a first bypass that bypasses the noise reduction processing unit 5.2.

Before the processed audio signal leaves the noise reduction 5, a first adder 5.3 performs a first merging of the sound signal leaving the noise reduction processing unit 5.2 and the sound signal from the first bypass. That first merging is not done by simply adding the two sound signals but by applying a first mixing ratio defined by the new set of hearing device settings based on the strength value.

Example: Let us assume that the earpiece of the hearing device has a vent with a cut-off frequency of 1.4 kHz. The fitting software calculated a strength value of “7” and calculated the second noise reduction setting based on that strength value. In the present embodiment, the strength value ranges from “1” leading to a minimal noise reduction content in the first mixing ratio to a “7” leading to a maximal noise reduction content in the first mixing ratio.

Step 29 in FIG. 3 re-programmed the default first sound enhancement setting in the form of the first mixing ratio in the hearing device 20 such that the adder now merges 95% of the audio signal leaving the noise reduction processing unit 5.2 with 5% of the audio signal arriving via the first bypass. The hearing device 20 has a lookup library of its own, for example in a DSP, in which the first adder 5.3 looks up the weighting factor for the sound signal leaving the noise reduction processing unit 5.2 and the weighting factor for the sound signal from the first bypass to achieve the desired 95% to 5% mixing ratio.

Note that the maximal strength of the noise reduction is indicated in the above embodiment as 95% of the sound signal leaving the noise reduction processing unit 5.2 but it can be a different percentage depending on other factors and preferences.

The actual noise reduction of the audio signal 13 entering the noise reduction processing unit 5.2 is done by way of a neural network unit (DNN unit) contained in the noise reduction processing unit 5.2. That model comprises the lessons learned from a neural network (DNN). In the present example, the DNN architecture was chosen to be a U-net with several layers and nodes according to the topological needs of the network. The DNN was trained with several datasets comprising speech only and comprising the same speech mixed with various background noise of different type and intensity. The DNN was indicated that that the desired output should be as close as possible to the dataset with the speech only such that an optimal SNR is obtained. The model in the DNN unit contains a weighting of training data, the speech quality, the total sound quality, and the amount of useful noise reduction to arrive at an optimal SNR with a low level of sound artifacts only. As a result, the processed audio signal leaving the noise reduction 5 contains less audio noise such that a listener can understand a spoken message contained in the input audio signal 1 better than if there was no noise reduction 5.

Note that in the present embodiment shown in FIG. 4, the sum of the weight factors applied to the audio signal leaving the noise reduction 5 and the audio signal leaving the first bypass equals the value of 1 (one).

Also note that the signal in the bypass is delayed such that it compensates for a time delay caused by the noise reduction processing unit 5.2. That delay is indicated by the reference character z1⁻¹.

Flowchart step 29 in FIG. 3 further re-programmed the default first sound enhancement setting in the form of the speech enhancement mixing ratio in the hearing device 20 such that the second adder now merges 80% of the audio signal leaving the speech enhancement processing unit 6.2 with 20% of the audio signal arriving via the first bypass. Again, the hearing device 20 has a lookup library of its own, for example in a DSP, in which the second adder 6.3 looks up the weighting factor for the sound signal leaving the speech enhancement processing unit 6.2 and the weighting factor for the sound signal from the second bypass to achieve the desired 80% to 20% mixing ratio.

Note that the maximal strength of the speech enhancement is indicated in the above embodiment as 80% of the sound signal leaving the speech enhancement processing unit 6.2 but it can be a different percentage depending on other factors and preferences. Also note that the signal in the bypass is delayed such that it compensates for a time delay caused by the speech enhancement processing unit 6.2. That delay is indicated by reference character z1⁻¹.

The actual speech enhancement of the audio signal 13 entering the speech enhancement processing unit 6.2 is done by way of a neural network unit (DNN unit) contained in the noise reduction processing unit 6.2. That model comprises the lessons learned from a neural network (DNN). As in case of the noise reduction 5 explained above, the DNN architecture was chosen to be a U-net with several layers and nodes according to the topological needs of the network. Again, the DNN was trained with several datasets to teach the DNN on how to enhance the speech and thus improve the understandability of a spoken message for the end user. Again, the model in the DNN unit contains a weighting of training data, the speech quality, the total sound quality, and speech enhancement to arrive at an optimal result with a low level of sound artifacts only.

Note that in the present embodiment shown in FIG. 4, the sum of the weight factors applied to the audio signal leaving the speech enhancement 6 and the audio signal leaving the second bypass equals the value of 1 (one).

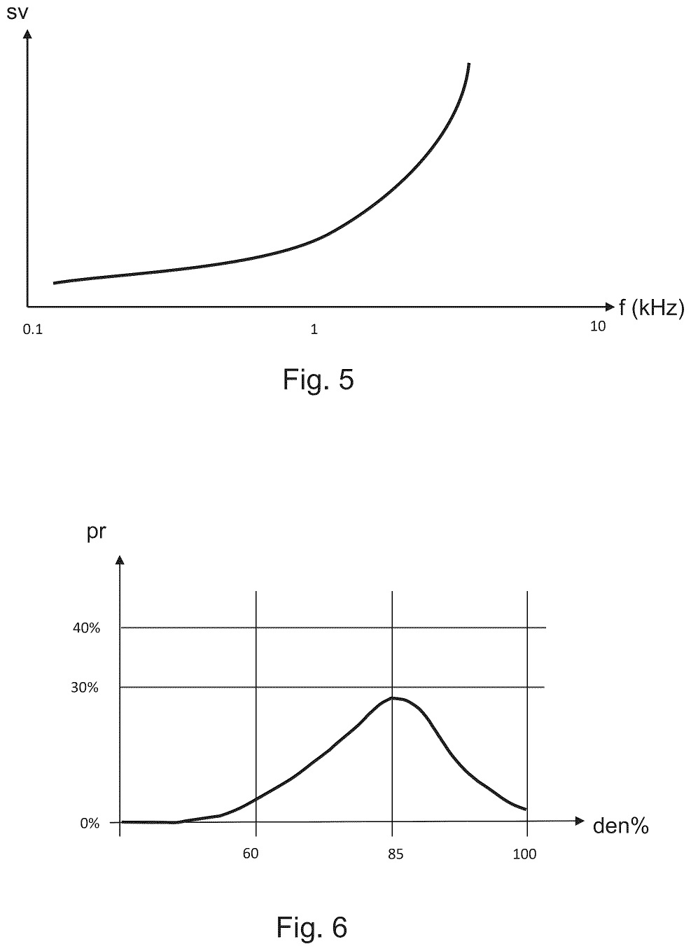

As a rule of thumb illustrated in FIG. 5, one can say that the tests with a group of test users equipped with hearing devices of various vent sizes that were exposed to the same sound scenes revealed the following: The higher the strength value (sv), the higher the SNR performance benefit (SNR-b) and the clearer a voice contained in the audio input signal is understood by the end user. This proves that having a strength value (sv) that directly steers the fitting process leads to a substantial improvement compared to the outcome when leaving the first sound enhancement setting as is without considering a verification of the correct vent cut-off frequence.

Moreover, note that it shall be possible that the HCP adjusts the strength value or the vent cut-off frequency manually, where needed. That manual adjustment can take place any time after the establishing a new set of hearing device settings for the hearing device in step g)—depicted as step/sequence stage 28. In such a case, the fitting software will re-calculate steps c) to e), replace the first sound enhancement setting in step f) and establish a new set of hearing device settings in step g) before it is transmitted to the hearing device according to step h).

FIG. 6 shows the statistic distribution of the outcome of a test with a group of participants under the test condition of a restaurant sound scene with lots of ambient noise while their hearing devices had a rather closed acoustic coupling. The vent of their earpieces had a rather small vent cut-off frequency (f) of less than 0.75 kHz and thus an AVM of more than 2.3.

The diagram shows that most of the test users preferred having a mixing ratio of about 85% audio signal from the noise reduction processing unit 5.2 to about 15% non-denoised audio signal from the first bypass in their hearing devices. The axis labelled with “pr” depicts the proportion of responses from the participants in percent while the axis labelled with “den %” depicts the percentage of audio signal ratio in the output signal that underwent a noise reduction processing. As one can see, a strength value leading to mixing ratio with a maximal noise reduction share and no (zero) bypass audio signal was not considered as preferable by the test users.

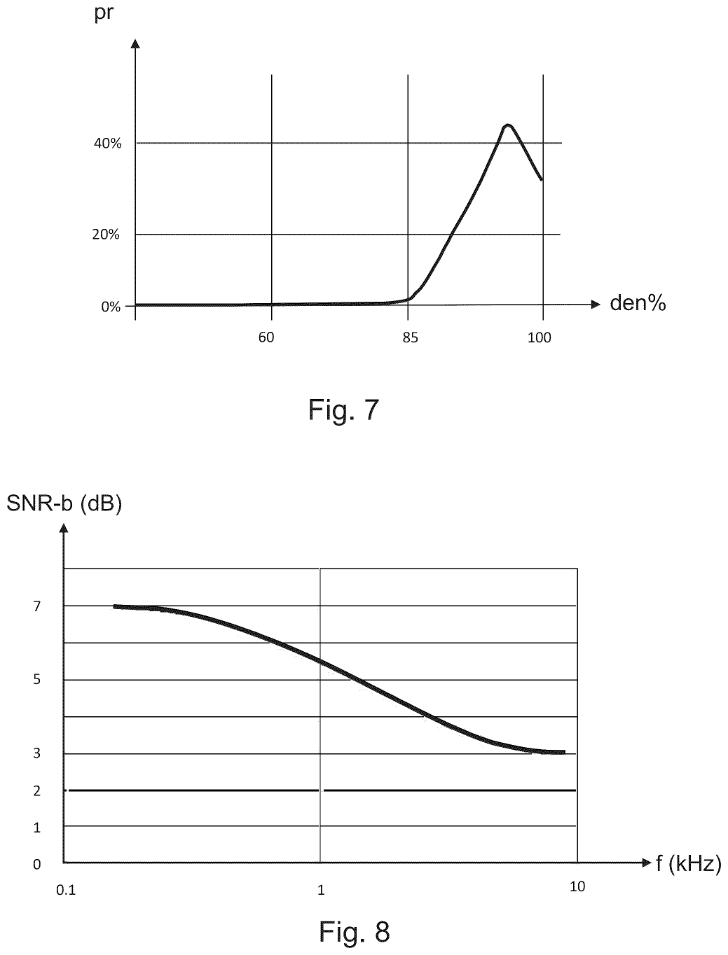

FIG. 7 shows the statistic distribution of the outcome of a test with a group of participants under the test condition of the same restaurant sound scene with lots of ambient noise mentioned in the context of the diagram leading to FIG. 6. This time, the hearing devices of the test users had an open acoustic coupling. The vent of their earpieces had a rather small vent cut-off frequency (f) of more than 1.3 kHz and thus an AVM of less than 1.0.

The diagram shows that most of the test users preferred having a mixing ratio of about 95% audio signal from the noise reduction processing unit 5.2 to about 5% non-denoised audio signal from the first bypass in their hearing devices. The axis labelled with “pr %” depicts the proportion of responses from the participants in percent while the axis labelled with “den %” depicts the percentage of audio signal ratio in the output signal that underwent a noise reduction processing, again. As one can see, a strength value leading to mixing ratio with a maximal noise reduction processing and no (zero) bypass audio signal was not considered as preferable by the test users, again.

When looking at the diagrams in FIGS. 6 and 7 together, it becomes evident that the test users clearly favored a weaker noise reduction and thus a weaker strength value for their hearing devices, whose earpieces had comparatively small vent sizes and a vent cut-off frequency below 0.75 kHz while they prefer a higher noise reduction and thus a higher strength value for hearing devices, whose earpieces had comparatively large vent sizes and a vent cut-off frequency of more than 1.3 kHz. Summing up, the test revealed that the users prefer the following reprogramming of their hearing device settings: The higher the vent cut-off frequency, the higher the strength of the noise reduction is required to counteract the vent-loss effect.

FIG. 8 shows a diagram with a schematic curve indicating the schematic signal-to-noise benefit for a typical gain configuration of the hearing device to an end user, indicated in the vertical axis as SNR-b in function to the vent cut-off frequencies f indicated in kHz indicated in the horizontal axis. On the one hand, this diagram shows that the end user cannot profit from a noise reduction any longer if the vent cut-off frequency exceeds a certain threshold. In this example, the threshold is at a vent cut-off frequency of about 1.3 KHz. This is because the ratio of direct sound to processed sound is such that the direct sound share dominates the sound mix at the eardrum and that even a maximal strength of the noise reduction, i.e., a maximal first mixing ratio cannot lead to a hearing benefit for the end user any longer. When looking at FIGS. 5 to 7 together, one can see that at a low vent cut-off frequency of less than 0.75 kHz, for example, where we have a closed coupling and where there is only comparatively little direct sound at the eardrum of the end user, the noise reduction effect of the noise reduction processing unit 5.2 in the hearing device 20 has a way higher impact and leads to a higher SNR-benefit for the end user than in case of an open coupling. The noise reduction intensity could technically even be higher, but the tests revealed that the test users did not consider that as preferred. Therefore, the default strength value leading to the first noise reduction enhancement setting should better be replaced by a lower strength value for a closed coupling situation before calculating the second noise reduction setting to meet that end user preference. The diagram in FIG. 8 further shows that if the hearing device of the user has an open coupling with a high vent cut-off frequency of more than 1.3 kHz, for example, but the same strength value as the one mentioned in the context of the closed coupling situation of FIG. 8 before, the SNR-benefit for the user is significantly smaller. In this example, the SNR-benefit is 4 dB smaller. To ensure that there is a still an SNR-benefit to the end user, the default strength value leading to the first noise reduction enhancement setting should better be replaced by a higher strength value for that open coupling situation before calculating the second noise reduction setting to meet the end user preference.

Summing up, since the strength value strength calculated in the fitting software directly steers the intensity degree of the noise reduction, the strength value is set to be higher for open couplings than for closed couplings before calculating the second sound enhancement setting. The same proves true for speech enhancement processes accordingly.

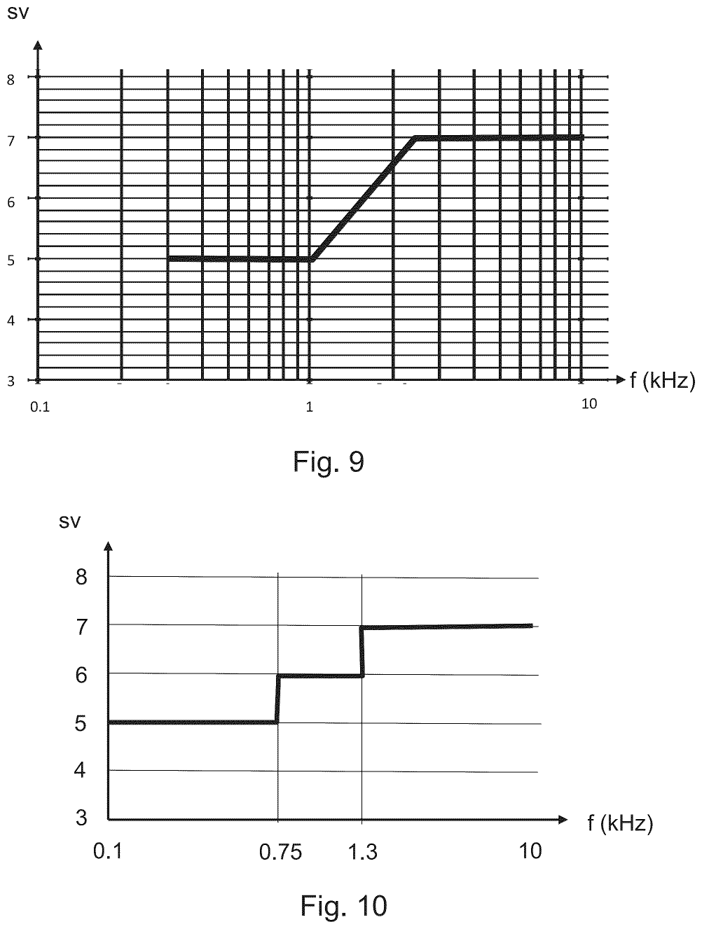

FIG. 9 shows a diagram where the strength value (sv) for a noise reduction is continuously monotonically mapped to the vent cut-off frequency. To avoid a harsh sudden jump of the strength value to another strength value level, the curve shows that the strength value is continuously increasing between two vent cut-off frequency thresholds that have chosen to be 1 kHz and 2.3 kHz in the present example. Applying such a discriminating model leads to the following effects: If the vent cut-off frequency is in a range between about 0.1 but lower than 1 kHz, say at 0.3 kHz, the strength value remains at the uniform lower level of the strength value “5” for the noise reduction. If the vent cut-off frequency is higher than 2.3 kHz, the strength value remains at the uniform higher strength value “7”.

In another discriminating model (not shown), the strength value could be mapped to the vent cut-off frequency in a continuous monotonic way across the entire vent cut-off frequency range.

FIG. 10 shows a diagram where the strength value for a noise reduction is continuously mapped to the vent cut-off frequency. In this embodiment, harsh jumps of the strength value are permitted between neighboring vent cut-off frequencies near a predefined vent cut-off frequency. In this model, the strength value (sv) is set to a value of a “5” leading to a moderate noise reduction intensity for all vent cut-off frequencies below 0.75 kHz. If the vent cut-off frequency is equal or bigger to 0.75 kHz but smaller than 1.3 kHz, the strength value is set uniformly to a strength value “6” that leads to medium noise reduction intensity. For vent cut-off frequencies of 1.3 kHz or higher, the strength value is set uniformly to “7” leading to a strong noise reduction intensity.

Compared to the discriminating model used as a basis for FIG. 9, the discriminating model applied in FIG. 10 requires less computational power in the operating state of the hearing device.

### LIST OF REFERENCE SYMBOLS

1 input audio signal
2 microphone
3 signal processing
4 sound strength adjustment
5 noise reduction
5.1 first splitter
5.2 noise reduction processing unit
5.3 first adder
6 speech enhancement
6.1 second splitter
6.2 speech enhancement processing unit
6.3 second adder
7 further sound tuning
8 receiver
9 processed sound path
10 direct sound path
11 ear canal
12 fitting software
13 audio signal
15 REOG curve with a vent-transmitted sound path for an open canal
16 REOG curve with a vent-transmitted sound path for a 3.5 mm vent size canal
17 REOG curve with a vent-transmitted sound path for a 2 mm vent size canal
18 REOG curve with a vent-transmitted sound path for a 1 mm vent size canal
19 REOG curve with a vent-transmitted sound path for an occluded canal
20 hearing device
21 connecting the hearing device to the fitting software
22 identifying the hearing device in the fitting software
23 feeding a vent cut-off frequency value of the hearing device to the fitting software
24 calculating a strength value in the fitting software
25 calculating a second noise reduction setting based on that strength value
26 calculating a second speech enhancement setting based on that strength value
27 replacing at least one of an existing noise reduction setting and an existing speech enhancement setting in the fitting software
28 establishing a new set of hearing device settings
29 transmitting the new set of the hearing device settings to the hearing device
30 custom shell earpiece

What is claimed is:

1. A method for fitting a hearing device to an end user, wherein the hearing device has as a vent, wherein the method comprises the steps of:
a) providing a hearing device having a first sound enhancement setting;
b) providing a fitting software,
c) feeding a vent cut-off frequency value of the hearing device to the fitting software,
d) calculating a strength value based on the vent cut-off frequency value,
e) calculating a second sound enhancement setting based on that strength value,
f) replacing the first sound enhancement setting in the fitting software by the second sound enhancement setting,
g) establishing a new set of hearing device settings for the hearing device, and
h) transmitting said new set of hearing device settings to the hearing device.

2. The method according to claim 1, characterized in that step h) reprograms the hearing device such that once the hearing device is in use, an audio signal is fed to a sound enhancement processing unit and a bypass that bypasses the sound enhancement processing unit in the hearing device, followed by a merging of the audio signal from the sound enhancement processing unit and the audio signal from the bypass in a mixing ratio defined by the new set of hearing device settings that are based on the strength value.

3. The method according to claim 2, characterized in that wherein the merging comprises a weighting of the sound signal from the sound enhancement processing unit and the sound signal from the bypass depending on the mixing ratio.

4. The method according to claim 2, characterized in that the signal in the bypass is delayed such that it compensates for a time delay caused by the processing of the sound signal in the sound enhancement processing unit.

5. The method according to claim 1, characterized in that the second sound enhancement setting comprises a second noise reduction setting for a noise reduction.

6. The method according to claim 5, characterized in that the second noise reduction setting steers at least one of the following functionalities:
Wiener filter-filter based SNR controlled gain reduction;
reduce comb filter effect;
sound relaxation; or
a noise reduction processing unit comprising a DNN model.

7. The method according to claim 1, characterized in that the second sound enhancement setting comprises a second speech enhancement setting for a speech enhancement.

8. The method according to claim 7, characterized in that the second speech enhancement setting steers at least one of the following functionalities:
accentuating acoustic signals arising of the input audio signal in a range of about 500 Hz to about 3000 Hz;
enhancement of spectral shape;
enhancement of intensity;
speech pattern processing;
enhancement by re-synthesis; or
a speech enhancement processing unit comprising a DNN model.

9. The method according to claim 7, characterized in that the there is a first mixing ratio for the noise reduction and a second mixing ratio for the speech enhancement.

10. The method according to claim 9, characterized in that the first mixing ratio is different to the second mixing ratio.

11. The method, according to claim 1, characterized in that the vent cut-off frequency value is fed to the fitting software by way of one of the members of the following group:
a default value obtained by the fitting software from a library based on an audiogram;
a coupling code that is fed into the fitting software;
the selection of an earpiece type and a vent size from a menu in the fitting software; or
measurement results of a feedback test available in the fitting software.

12. The method according to claim 1, characterized in that
as long as the vent cut-off frequency value is below a predefined vent cut-off frequency threshold value, a first strength value is applied, and
if the vent cut-off frequency value is at or above that predefined vent cut-off frequency threshold value, a second strength value is applied,
wherein the second strength value is different to the first strength value.

13. The method according to claim 1, characterized in that the strength value is mappable to the vent cut-off frequency value in a continuous monotonic way.

14. The method according to claim 1, characterized in that the higher the vent cut-off frequency, the higher the strength value.

15. A computer program product forming a fitting software, characterized in that the computer program product comprises a computer code to perform the method according to claim 1.
